(19) United States
(12) Patent Application Publication
(10) Pub. No.: US 2026/0052467 A1
(43) Pub. Date: Feb. 19, 2026

(54) ENHANCED CELL ON-/OFF-SWITCHING

(71) Applicant: Nokia Technologies Oy, Espoo (FI)

(72) Inventors: Hakon HELMERS, Massy (FR); Daniela LASELVA, Aalborg (DK)

(21) Appl. No.: 19/101,106

(22) PCT Filed: Aug. 5, 2022
(86) PCT No.: PCT/EP2022/072129

§ 371 Date: Feb. 4, 2025

(51) Int. Cl. H04W 52/02; H04L 5/00; H04L 43/0876

(52) U.S. Cl. CPC H04W 52/0206; H04L 5/0053; H04L 43/0876

(57) ABSTRACT

There are provided measures for (enabling/realizing) efficient/favorable cell switch-on/off decisions in/for a radio access network of a mobile communication system, which can be applicable in a (distributed/disaggregated/split) configuration/architecture such as a CU-DU configuration/architecture. Such measures exemplarily comprise that a lower-layer entity in/for a radio access network of a mobile communication system obtains a cell designation, including an indication of one or more cells allowed to be switched on/off by the lower-layer entity, from a higher-layer entity in the radio access network, detects a cell switch-on/off condition for at least one cell based on at least a load condition, and triggers a cell switch-on/off of the at least one cell when the at least one cell is indicated in the cell designation.

### FIELD

The present disclosure relates to enhanced cell on-/off-switching. More specifically, the present disclosure relates to measures/mechanisms (including methods, apparatuses (i.e. devices, entities, elements, instances and/or functions) and computer program products) for enabling/realizing enhanced cell on-/off-switching in/for a radio access network of a mobile communication system.

### BACKGROUND

The present disclosure basically relates to cell on-/off-switching, i.e. cell re-/activation and deactivation in/for (a radio access network of) a mobile communication system, e.g. a 3GPP-standardized mobile/wireless communication system, such as a 5G/NR system and a next-generation system beyond 5G. In this regard, cells can be switched off (or deactivated) so as to be inactive, where inactive cells are known by the communication control entity (such as a gNB or 5G base station) but do not serve any communication entity (such as a UE), and cells can be switched on (or re-/activated) so as to be active, wherein active cells are known by the communication control entity (such as a gNB or 5G base station) and can serve communication entities (such as UEs).

Reducing the energy consumption of a mobile/wireless communication system, and particularly of the radio access network, which consumes the largest part of the total energy in the system, has recently gained attention. Accordingly, enhancements for network energy saving are desired in a mobile/wireless communication system, such as a 5G/NR system and a next-generation system beyond 5G.

Currently, network energy saving can be achieved using the known network proprietary solutions including:
Infrequent Synchronization Signal Block (SSB) transmission, e.g. SSB periodicity of 160 ms could be considered in empty/low load situation.
Micro DTx, which consists in shutting down the power amplifier on a per OFDM symbol basis, in symbols that do not carry data nor signaling.
Based on network architecture and capability, further components could be shut down (e.g. transmit antennas as in mMIMO muting, baseband circuity).
Total cells switch-off (i.e. cell shutdown/deactivation), which allows to switch off one or more cells, e.g. at a given frequency layer, and hence to switch off most of the hardware components of the corresponding radio unit and/or radio access network site.

Hereinafter, focus is made on the cell switch-off, particularly in (distributed/disaggregated/split) configuration/architecture, in which the gNB is distributed/disaggregated/split into gNB-CU and gNB-DU(s).

In terms of a cell switch-off procedure over the F1-AP, i.e. the interface between a gNB-CU and a gNB-DU pair, the following two cell states are possible:
Inactive cell: the cell is known by both the gNB-DU and gNB-CU, but it shall not serve UEs.
Active cell: the cell is known by both the gNB-DU and gNB-CU, and should try to provide services to the UEs.

The gNB-CU decides whether the Cell State should be “Inactive” or “Active”, and the gNB-CU can request the gNB-DU to change the cell state of any of its served/controlled cells. In the context of cell activation, as currently specified/standardized, the gNB-CU can provide the cell switch-on/off request using a F1 SETUP RESPONSE message or a GNB-CU CONFIGURATION UPDATE message, including a Cells to be Activated List IE, i.e. a list of cells that the gNB-CU requests the gNB-DU to activate, and the gNB-DU shall activate the cells included in the Cells to be Activated List IE and reconfigure the physical cell identity for cells for which the NR PCI IE is included. In the context of DU configuration, as currently specified/standardized, the gNB-CU can provide the cell switch-on/off request using a GNB-DU CONFIGURATION UPDATE ACKNOWLEDGE message, including a Cells to be Activated List Item IE, i.e. a list of cells that the gNB-CU requests the gNB-DU to activate, and the gNB-DU shall activate the cells indicated by NR CGI IE, or including a Cells to be Deactivated List Item IE, i.e. a list of cells that the gNB-CU requests the gNB-DU to deactivate, and the gNB-DU shall deactivate the cells indicated by NR CGI IE.

Cell switch-off or, stated in other words, cell shutdown during low load periods is one of the most effective means to achieve network energy saving. This is because all the power-hungry hardware components of the cell can be turned off (e.g. the power amplifier), and thus significant energy consumption reduction can be achieved.

As described above, in the (distributed/disaggregated/split) configuration/architecture, the CU is responsible for the decision of whether a certain cell should be switched on or off (also referred to cell re-/activation and deactivation). Accordingly, the CU informs or requests the DU that the DU should activate or deactivate certain cells. In case of cell switch-off, the DU then enforces the cell offloading and cell deactivation, e.g. by gradually decreasing the SSB transmit power. Likewise, in case of cell switch-on, the DU then enforces the cell re-/activation, e.g. by gradually increasing gradually the SSB transmit power.

However, the CU lacks precise information, such as information about the cell load and other cell-related information, such as energy properties (such as energy efficiency or current energy consumption) of the cell and hence about an energy saving gain or potential in case of switch-off. In order to make the cell switch-on/off decision, the CU may acquire the load status per cell from the DU, but exchange of other cell-related information such as energy property related information or the like is not specified/standardized. Hence, the CU cannot utilize such cell-related information, at least in a general or multi/inter-vendor environment.

Therefore, there is room for improvement and a desire/need for a technique for (enabling/realizing) efficient/favorable cell switch-on/off decisions in/for a radio access network of a mobile communication system. In particular, there is room for improvement and a desire/need for a technique for (enabling/realizing) enhanced cell on-/off-switching in/for a radio access network of a mobile communication system, which is applicable in a (distributed/disaggregated/split) configuration/architecture such as a CU-DU configuration/architecture.

### SUMMARY

Various exemplifying embodiments of the present disclosure aim at addressing at least part of the above issues and/or problems and drawbacks.

Various aspects of exemplifying embodiments of the present disclosure are set out in the appended claims.

According to an example aspect of the present disclosure, there is provided a method, which can be a method of/for (or, stated in other words, operable or for use in/by) a lower-layer entity for/in a radio access network of a mobile communication system, comprising: obtaining a cell designation, including an indication of one or more cells allowed to be switched on/off by the lower-layer entity among cells served by the lower-layer entity, from a higher-layer entity in the radio access network, detecting a cell switch-on/off condition for at least one cell based on at least a load condition of cells served by the lower-layer entity, and triggering a cell switch-on/off of the at least one cell when the at least one cell is indicated in the cell designation.

According to an example aspect of the present disclosure, there is provided an apparatus, which can be an apparatus of/for (or, stated in other words, operable or for use in/by) a lower-layer entity for/in a radio access network of a mobile communication system, comprising: means for obtaining a cell designation, including an indication of one or more cells allowed to be switched on/off by the lower-layer entity among cells served by the lower-layer entity, from a higher-layer entity in the radio access network, means for detecting a cell switch-on/off condition for at least one cell based on at least a load condition of cells served by the lower-layer entity, and means for triggering a cell switch-on/off of the at least one cell when the at least one cell is indicated in the cell designation.

According to an example aspect of the present disclosure, there is provided an apparatus, which can be an apparatus of/for (or, stated in other words, operable or for use in/by) a lower-layer entity for/in a radio access network of a mobile communication system, comprising at least one processor; and at least one memory storing instructions that, when executed by the at least one processor, cause the apparatus at least to perform: obtaining a cell designation, including an indication of one or more cells allowed to be switched on/off by the lower-layer entity among cells served by the lower-layer entity, from a higher-layer entity in the radio access network, detecting a cell switch-on/off condition for at least one cell based on at least a load condition of cells served by the lower-layer entity, and triggering a cell switch-on/off of the at least one cell when the at least one cell is indicated in the cell designation.

According to an example aspect of the present disclosure, there is provided an apparatus, which can be an apparatus of/for (or, stated in other words, operable or for use in/by) a lower-layer entity for/in a radio access network of a mobile communication system, comprising: circuitry configured to obtain a cell designation, including an indication of one or more cells allowed to be switched on/off by the lower-layer entity among cells served by the lower-layer entity, from a higher-layer entity in the radio access network, circuitry configured to detect a cell switch-on/off condition for at least one cell based on at least a load condition of cells served by the lower-layer entity, and circuitry configured to trigger a cell switch-on/off of the at least one cell when the at least one cell is indicated in the cell designation.

According to various developments/modifications, any one of the aforementioned method-related and/or apparatus-related example aspects of the present disclosure may include one or more of the following features:
the method, functionality or operability (of/regarding detecting) comprises monitoring, as the load condition, cell load levels of cells served by the lower-layer entity,
the method, functionality or operability (of/regarding detecting) comprises determining suitability of a cell switch-on/off based on at least the load condition, and selecting the at least one cell for being switched on/off,
the cell designation includes an indication of one or more cells allowed to be switched off by the lower-layer entity, a cell switch-off condition is detected for the at least one cell, and a cell switch-off of the at least one cell is triggered when the at least one cell is indicated in the cell designation as a cell allowed to be switched off by the lower-layer entity,
detecting the cell switch-off condition for the at least one cell comprises determining suitability of a cell switch-off when the load condition indicates decreasing, low or no load, and selecting the at least one cell for being switched off based on cell-related information available at the lower-layer entity,
the cell-related information comprises information on one or more of energy efficiency, energy consumption and energy saving gain or potential of cells served by the lower-layer entity,
the method, functionality or operability (of/regarding triggering) comprises initiating cell offloading and cell deactivation,
the cell designation includes an indication of one or more cells allowed to be switched on by the lower-layer entity, a cell switch-on condition is detected for the at least one cell, and a cell switch-on of the at least one cell is triggered when the at least one cell is indicated in the cell designation as a cell allowed to be switched on by the lower-layer entity,
detecting the cell switch-on condition for the at least one cell comprises determining suitability of a cell switch-on when the load condition indicates increasing or high load or when the load condition indicates increasing or high load and one or more key performance indicators are decreasing, and selecting the at least one cell for being switched on based on cell-related information available at the lower-layer entity,
the cell-related information comprises information on one or more of energy efficiency, energy consumption and energy saving gain or potential of cells served by the lower-layer entity,
the method, functionality or operability (of/regarding triggering) comprises initiating cell re-/activation,
the method, functionality or operability (of/regarding obtaining) comprises receiving a message including the cell designation from the higher-layer entity, wherein the message is or comprises a setup response message or a configuration update message or a configuration update acknowledgment message,
the method, functionality or operability comprises notifying the higher-layer entity of the cell switch-on/off being triggered,
the cell switch-on/off is notified before and/or after the triggered cell switch-on/off is enforced,
the method, functionality or operability (of/regarding notifying) comprises providing energy state information including at least an energy state of the at least one cell,
the method, functionality or operability (of regarding notifying) comprises providing additional information including one or more of an expected time of the cell switch-on/off, a current load condition or cell load level before the cell switch-on/off, an expected or estimated load condition or cell load level after the cell switch-on/off, and an expected or estimated value of one or more key performance indicators after the cell switch-on/off,
the energy state comprises one of active, inactive, switch-off ongoing for energy saving reasons, and switched-off for energy saving reasons,
the method, functionality or operability (of/regarding notifying) comprises transmitting a message including energy state information and/or additional information to the higher-layer entity, wherein the message is or comprises a configuration update message or a configuration update acknowledgment message,
the method, functionality or operability comprises obtaining a request for a cell switch-on/off from the higher-layer entity, and cancelling the triggered cell switch-on/off when the requested cell switch-on/off differs from the triggered cell switch-on/off,
the lower-layer entity is or comprises a functional unit providing support for lower layers, such as Layer 1 and/or Layer 2, of a protocol stack for communication in the radio access network and/or the mobile communication system,
the lower-layer entity is or comprises a distributed unit of a communication control element or function in the radio access network and, such as a base station or Node B,
the higher-layer entity is or comprises a functional unit providing support for higher layers, such as Layer 3, of a protocol stack for communication in the radio access network and/or the mobile communication system,
the higher-layer entity is or comprises a central unit of a communication control element or function in the radio access network and, such as a base station or Node B,
the lower-layer entity and the higher-layer entity belong to a communication control element or function in the radio access network and, such as a base station or Node B, in distributed/split architecture.

According to an example aspect of the present disclosure, there is provided a method, which can be a method of/for (or, stated in other words, operable or for use in/by) a higher-layer entity in a radio access network of a mobile communication system, comprising: setting, among cells served by a lower-layer entity in the radio access network, one or more cells allowed to be switched on/off by the lower-layer entity, and providing a cell designation, including an indication of the one or more cells allowed to be switched on/off by the lower-layer entity, to the lower-layer entity.

According to an example aspect of the present disclosure, there is provided an apparatus, which can be an apparatus of/for (or, stated in other words, operable or for use in/by) a higher-layer entity in a radio access network of a mobile communication system, comprising: means for setting, among cells served by a lower-layer entity in the radio access network, one or more cells allowed to be switched on/off by the lower-layer entity, and means for providing a cell designation, including an indication of the one or more cells allowed to be switched on/off by the lower-layer entity, to the lower-layer entity.

According to an example aspect of the present disclosure, there is provided an apparatus, which can be an apparatus of/for (or, stated in other words, operable or for use in/by) a higher-layer entity in a radio access network of a mobile communication system, comprising: at least one processor; and at least one memory storing instructions that, when executed by the at least one processor, cause the apparatus at least to perform: setting, among cells served by a lower-layer entity in the radio access network, one or more cells allowed to be switched on/off by the lower-layer entity, and providing a cell designation, including an indication of the one or more cells allowed to be switched on/off by the lower-layer entity, to the lower-layer entity.

According to an example aspect of the present disclosure, there is provided an apparatus, which can be an apparatus of/for (or, stated in other words, operable or for use in/by) a higher-layer entity in a radio access network of a mobile communication system, comprising: circuitry configured to set, among cells served by a lower-layer entity in the radio access network, one or more cells allowed to be switched on/off by the lower-layer entity, and circuitry configured to provide a cell designation, including an indication of the one or more cells allowed to be switched on/off by the lower-layer entity, to the lower-layer entity.

According to various developments/modifications, any one of the aforementioned method-related and/or apparatus-related example aspects of the present disclosure may include one or more of the following features:
the method, functionality or operability (of/regarding providing) comprises transmitting a message including the cell designation to the lower-layer entity, wherein the message is or comprises a setup response message or a configuration update message or a configuration update acknowledgment message,
the method, functionality or operability comprises obtaining a notification of a cell switch-on/off triggered by the lower-layer entity from the lower-layer entity,
the notification comprises energy state information including at least an energy state of at least one cell being subjected to a cell switch-on/off triggered by the lower-layer entity,
the notification comprises additional information including one or more of an expected time of a cell switch-on/off triggered by the lower-layer entity, a current load condition or cell load level before a cell switch-on/off triggered by the lower-layer entity, an expected or estimated load condition or cell load level after a cell switch-on/off triggered by the lower-layer entity, and an expected or estimated value of one or more key performance indicators after a cell switch-on/off triggered by the lower-layer entity,
the energy state comprises one of active, inactive, switch-off ongoing for energy saving reasons, and switched-off for energy saving reasons,
the method, functionality or operability (of/regarding obtaining) comprises receiving a message including energy state information and/or additional information from the lower-layer entity, wherein the message is or comprises a configuration update message or a configuration update acknowledgment message,
the method, functionality or operability comprises storing the energy state information and/or the additional information, and controlling an operation based on the stored information,
the operation comprises one or more of paging, monitoring load conditions or levels across multiple lower-layer entities under control of the higher-layer entity, informing a communication control element or function in the radio access network, such as a base station or Node B, and deciding on suitability of requesting a cell switch-on/off at the lower-layer entity upon obtaining a cell switch-on/off request,
the lower-layer entity is or comprises a functional unit providing support for lower layers, such as Layer 1 and/or Layer 2, of a protocol stack for communication in the radio access network and/or the mobile communication system,
the lower-layer entity is or comprises a distributed unit of a communication control element or function in the radio access network and, such as a base station or Node B,
the higher-layer entity is or comprises a functional unit providing support for higher layers, such as Layer 3, of a protocol stack for communication in the radio access network and/or the mobile communication system,
the higher-layer entity is or comprises a central unit of a communication control element or function in the radio access network and, such as a base station or Node B,
the lower-layer entity and the higher-layer entity belong to a communication control element or function in the radio access network and, such as a base station or Node B, in distributed/split architecture.

According to an example aspect of the present disclosure, there is provided a computer program product comprising (computer-executable) computer program code which, when the program code is executed (or run) on a computer or the program is run on a computer (e.g. a computer of an apparatus according to any one of the aforementioned apparatus-related example aspects of the present disclosure), is configured to cause the computer to carry out the method according to the aforementioned method-related example aspect of the present disclosure.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned exemplary aspects of the present disclosure are set out in the following.

By way of exemplifying embodiments of the present disclosure, a technique for (enabling/realizing) efficient/favorable cell switch-on/off decisions in/for a radio access network of a mobile communication system can be enabled/realized. Also, a technique for (enabling/realizing) enhanced cell on-/off-switching in/for a radio access network of a mobile communication system, which is applicable in a (distributed/disaggregated/split) configuration/architecture such as a CU-DU configuration/architecture, can be enabled/realized.

### BRIEF DESCRIPTION OF THE DRAWINGS

In the following, the present disclosure will be described in greater detail by way of non-limiting examples with reference to the accompanying drawings, in which

FIG. 1 shows a flowchart illustrating an example of a method or process according to at least one exemplifying embodiment,

FIG. 2 shows a flowchart illustrating an example of a method or process according to at least one exemplifying embodiment,

FIG. 3 shows a sequence diagram illustrating an example of a procedure according to at least one exemplifying embodiment,

FIG. 4 shows a sequence diagram illustrating an example of a procedure according to at least one exemplifying embodiment,

FIG. 5 shows a schematic block diagram illustrating an example of a structure of apparatuses according to at least one exemplifying embodiment, and

FIG. 6 shows a schematic block diagram illustrating an example of a structure of apparatuses according to at least one exemplifying embodiment.

### DETAILED DESCRIPTION

The present disclosure is described herein with reference to particular non-limiting examples and to what are presently considered to be conceivable (examples of) embodiments. A person skilled in the art will appreciate that the present disclosure is by no means limited to these examples and embodiments, and may be more broadly applied.

It is to be noted that the following description mainly refers to specifications being used as non-limiting examples for certain exemplifying network configurations and system deployments. Namely, the following description mainly refers to 3GPP standards, being used as non-limiting examples. As such, the description of exemplifying embodiments given herein specifically refers to terminology which is directly related thereto. Such terminology is only used in the context of the presented non-limiting examples and embodiments, and does naturally not limit the present disclosure in any way. Rather, any other system configuration or deployment may equally be utilized as long as complying with what is described herein and/or exemplifying embodiments described herein are applicable to it.

For example, the present disclosure is equally applicable in any (mobile/wireless) communication system, such as 5G/NR systems and next-generation systems beyond 5G. For example, the present disclosure is applicable in 3GPP-standardized mobile/wireless communication system of Release 18 onwards.

Hereinafter, various exemplifying embodiments and implementations of the present disclosure and its aspects are described using several variants and/or alternatives. It is generally to be noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is to be noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown. In flowcharts or sequence diagrams, the illustrated order of operations or actions is generally illustrative/exemplifying, and any other order of respective operations or actions is equally conceivable, if feasible.

According to exemplifying embodiments of the present disclosure, in general terms, there are provided measures/mechanisms for enabling/realizing enhanced cell on-/off-switching in/for a radio access network of a mobile communication system.

It is to be noted that herein switching generally refers to changing a cell state or cell activation/energy state, encompassing both on-and off-switching, which can equally be referred to as re-/activation and deactivation. Accordingly, the same principles according to exemplifying embodiments generally apply to both cases in equal measure. As the case may be, switching can be understood as on-switching or re-/activation of cells being currently switched off or deactivated/inactive (i.e. in an inactive cell state or cell activation/energy state), and switching can be understood as off-switching or deactivation of cells being currently switched on or activated/active (i.e. in an active cell state or cell activation/energy state).

Hereinafter, a specific (distributed/disaggregated/split) configuration/architecture of a radio access network, particularly a communication control entity (such as a gNB or 5G base station) in/for a radio access network, of a 3GPP-based/related system, is assumed as a basis, for illustrating exemplifying embodiments (without limiting the present disclosure accordingly). Namely, it is assumed that the radio access network or the communication control entity (such as a gNB or 5G base station) comprises plural lower-layer entities for controlling and/or supporting and/or accomplishing lower-layer operability, such as L1/L2 operability, and a higher-layer entity for controlling and/or supporting and/or accomplishing higher-layer operability, such as L3 operability. The higher-layer entity may be (logically and/or functionally and/or physically) split into a higher-layer control plane entity for handling control plane (CP) operability and a higher-layer user plane entity for handling user plane (UP) operability. Each of the lower-layer entities may be (realized by or in) a Distributed Unit DU (of/in a gNB or 5G base station), and the higher-layer entity may be (realized by or in) a Central Unit CU (of/in a gNB or 5G base station).

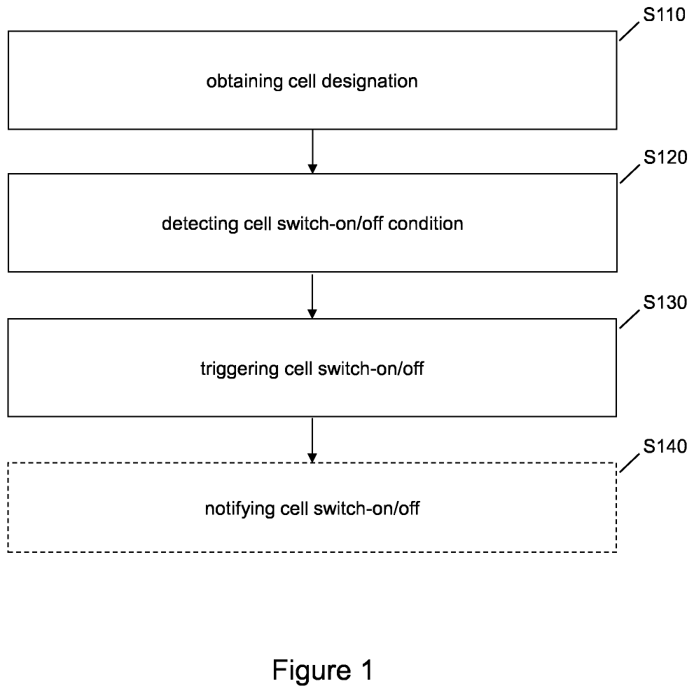

FIG. 1 shows a flowchart illustrating an example of a method or process according to at least one exemplifying embodiment. The method or process of FIG. 1 is a method or process of (or, stated in other words, operable or for use in/by) a lower-layer entity, or an element, function or entity of similar/comparable functionality or operability, in/for a radio access network of a mobile communication system, such as a communication and/or communication control unit like a Distributed Unit DU (of/in a gNB or 5G base station) in/for a 3GPP network or system. Hereinafter, reference is made to a “lower-layer entity” and a corresponding/related (i.e. controlling or superordinate) “higher-layer entity”, for the sake of ease of description.

As shown in FIG. 1, the method or process comprises an operation (S110) of obtaining a cell designation (as a designation of one or more cells), including an indication of one or more cells allowed to be (autonomously/locally) switched on/off by the lower-layer entity (i.e. one or more cells, the cell state or cell activation/energy state is allowed to be switched/changed by the lower-layer entity) among cells served by the lower-layer entity, from a higher-layer entity in the radio access network, an operation (S120) of detecting a cell switch-on/off condition for at least one cell based on at least a load condition of cells served by the lower-layer entity, and an operation (S130) of triggering a cell switch-on/off of the at least one cell when the at least one cell is indicated in the cell designation.

As indicated by a dashed-line box in FIG. 1, the method or process may also comprise an operation (S140) of notifying the higher-layer entity of the cell switch-on/off being triggered.

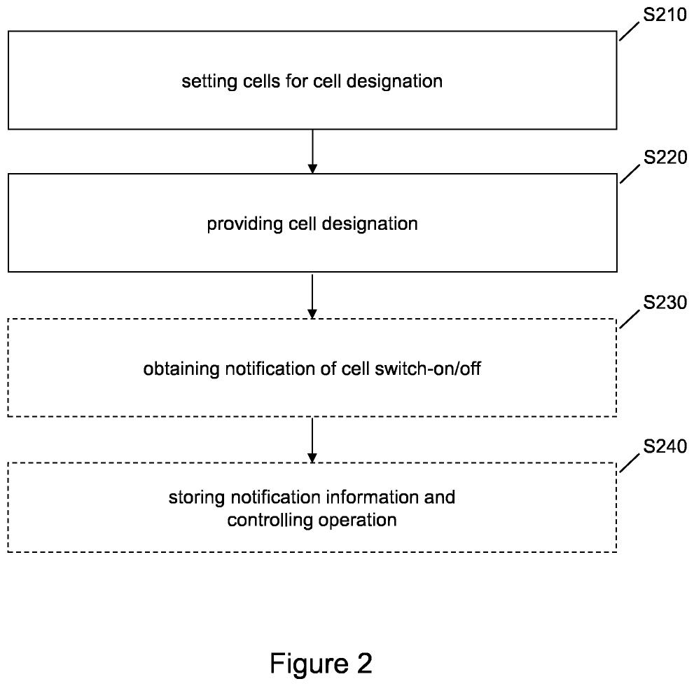

FIG. 2 shows a flowchart illustrating an example of a method or process according to at least one exemplifying embodiment. The method or process of FIG. 2 is a method or process of (or, stated in other words, operable or for use in/by) a higher-layer entity, or an element, function or entity of similar/comparable functionality or operability, in/for a radio access network of a mobile communication system, such as a communication and/or communication control unit like a Central Unit CU (of/in a gNB or 5G base station) in/for a 3GPP network or system. Hereinafter, reference is made to a “higher-layer entity” and a corresponding/related (i.e. controlled or subordinate) “lower-layer entity”, for the sake of ease of description.

As shown in FIG. 2, the method or process comprises an operation (S210) of setting, among cells served by a lower-layer entity in the radio access network, one or more cells allowed to be (autonomously/locally) switched on/off by the lower-layer entity (i.e. one or more cells, the cell state or cell activation/energy state is allowed to be switched/changed by a lower-layer entity), and an operation (S220) of providing a cell designation (as a designation of one or more cells), including an indication of the one or more cells allowed to be (autonomously/locally) switched on/off by the lower-layer entity, to the lower-layer entity.

As indicated by dashed-line boxes in FIG. 2, the method or process may further comprise an operation (S230) of obtaining a notification of a cell switch-on/off triggered by the lower-layer entity from the lower-layer entity, and the method or process may still further comprise an operation (S240) of storing energy state information and/or additional information included in the notification and controlling an operation based on the stored information.

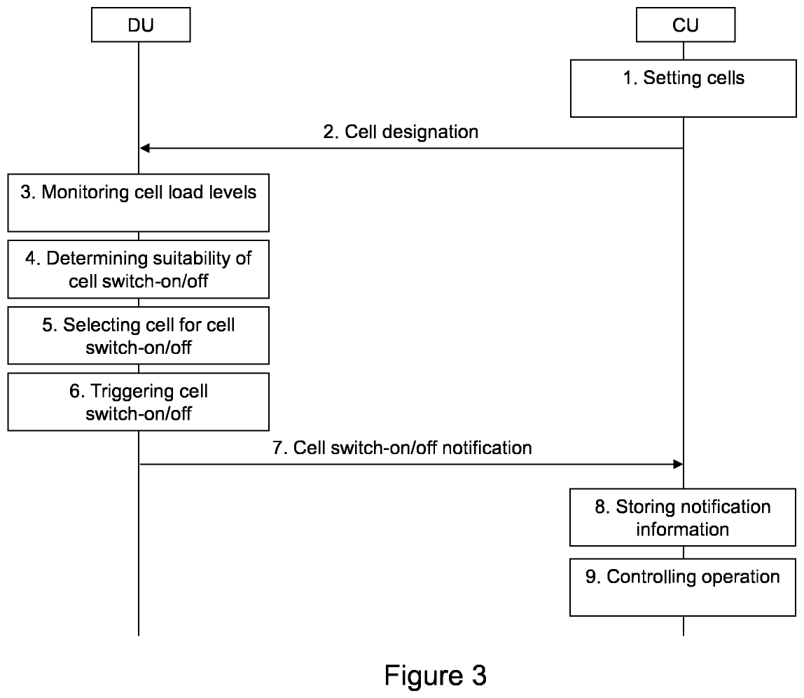

FIG. 3 shows a sequence diagram illustrating an example of a procedure according to at least one exemplifying embodiment. The procedure of FIG. 3 is a procedure between a lower-layer entity, or an element, function or entity of similar/comparable functionality or operability, which is denoted by DU, and a higher-layer entity, or an element, function or entity of similar/comparable functionality or operability, which is denoted by CU, which correspond/relate to each other e.g. by being involved in the same communication control entity (such a gNB or 5G base station) in/for a 3GPP network or system.

It is to be noted that the subsequent description of FIG. 3 refers to both cases of on-/off-switching, i.e. re-/activation and deactivation, while the procedure of FIG. 3 is equally applicable for any one of these cases, respectively.

As shown in FIG. 3, the CU can set, among cells served by the DU, one or more cells allowed to be to (autonomously/locally) activated and/or deactivated by the DU (step 1). Such cell setting may be based on various quantities, parameters or values. For example, a carrier frequency of a cell can be considered for the cell setting, wherein e.g. cells operating at the lower/lowest carrier frequency shall not be designated for switch-off as they provide coverage and should preferably not be switched off (by the DU). Then, the CU can provide information to the DU about the one or more cells that the DU is allowed to (autonomously/locally) activate and/or deactivate (step 2). According to exemplifying embodiments, such information is denoted as cell designation. The cell designation may be transmitted by the CU and received by the DU in a message which may be or comprise a setup response message (such as e.g. F1 SETUP RESPONSE) or a configuration update message (such as e.g. GNB-CU CONFIGURATION UPDATE) or a configuration update acknowledgment message (such as e.g. GNB-DU CONFIGURATION UPDATE ACKNOWLEDGE). As an example, the cell designation may be provided, e.g. in such a message, by a dedicated information element (IE) such as a Cells Allowed to be Activated by DU List IE and/or a Cells Allowed to be Deactivated by DU List IE. In the cell designation, such as a corresponding information element, the targeted cells can be defined by any suitable (cell) identifier such as e.g. NR CGIs and/or PCIs.

Upon obtaining the cell designation, the DU can detect a cell switch-on/off condition for at least one cell based on at least a load condition of cells served by the DU. Such detection may comprise that the DU monitors, as the load condition, cell load levels of cells served by the DU (step 3), and/or may comprise that the DU determines suitability (such as e.g. need, appropriateness, expedience, or the like) of a cell switch-on/off based on at least the load condition and selects the at least one cell for being switched on/off (steps 4 and 5).

In the switch-off case, i.e. DU-triggered cell switch-off or deactivation, the cell designation includes an indication of one or more cells allowed to be (autonomously/locally) deactivated by the DU, as the targeted cells, as mentioned above. Then, the DU can monitor the cell load levels of (any one of) its (currently active) controlled/served cells so as to determine their load conditions (step 3). Based on the load conditions, the DU can determine the suitability or need to switch off at least one cell based on load conditions such as low/no load or decreasing load e.g. below a threshold (step 4), and select the cell(s) to be switched off, among the cell(s) for which the switch-off suitability or need is determined, based on e.g. locally available energy efficiency or energy saving information (step 5). If the cell(s) selected to be switched off is (are) included in the cell designation from the CU, i.e. is indicated in/as/by the one or more cells allowed to be (autonomously/locally) deactivated by the DU, it can be said that a cell switch-off condition is detected for this (these) cell(s), and the DU can immediately trigger (or initiate) corresponding cell switch-off of this (these) cell(s) (step 6). Switching off cells by the DU can comprise cell offloading and subsequent/actually cell switch-off, which can be realized by decreasing SSB transmit power. When triggering cell switch-off, the DU can inform the CU accordingly by notifying the DU of the cell switch-off being triggered, which is denoted by cell switch-on/off notification here (step 7). Such notification can include an identification of the concerned cell(s), i.e. any suitable (cell) identifier such as e.g. NR CGIs and/or PCIs, and/or can include energy state information and/or additional information, as described in more detail below. For example, the DU can inform the CU about cell switch-off for energy saving reason.

In the switch-on case, i.e. DU-triggered cell switch-on or re-/activation, the cell designation includes an indication of one or more cells allowed to be (autonomously/locally) activated by the DU, as the targeted cells, as mentioned above. Then, the DU can monitor the cell load levels of (any one of) its (currently active) controlled/served cells so as to determine their load conditions (step 3). Based on the load conditions, the DU can determine the suitability or need to switch on at least one cell based on load conditions such as high/full load or increasing load e.g. above a threshold and/or other relevant conditions such as e.g. decreasing KPIs such as e.g. end-user throughput, cell throughput, packet latency, or the like (step 4), and select the cell(s) to be switched on, among the cell(s) for which the switch-on suitability or need is determined, based on e.g. locally available energy efficiency or energy saving information (step 5). If the cell(s) selected to be switched on is (are) included in the cell designation from the CU, i.e. is indicated in/as/by the one or more cells allowed to be (autonomously/locally) activated by the DU, it can be said that a cell switch-on condition is detected for this (these) cell(s), and the DU can immediately trigger (or initiate) corresponding cell switch-on of this (these) cell(s) (step 6). Switching on cells by the DU can be realized by increasing SSB transmit power. When triggering cell switch-on, the DU can inform the CU accordingly by notifying the DU of the cell switch-on being triggered, which is denoted by cell switch-on/off notification here (step 7). Such notification can include an identification of the concerned cell(s), i.e. any suitable (cell) identifier such as e.g. NR CGIs and/or PCIs, and/or can include energy state information and/or additional information, as described in more detail below.

In any case, the cell switch-on/off notification may be transmitted by the DU and received by the CU in a message which may be or comprise a configuration update message (such as e.g. GNB-DU CONFIGURATION UPDATE) or a configuration update acknowledgment message (such as e.g. GNB-CU CONFIGURATION UPDATE ACKNOWLEDGE).

Upon obtaining the cell switch-on/off notification, the CU can store information included in the notification, such as the energy state information and/or the additional information (step 8), and the CU can control an operation based on the stored information (step 9), as described in more detail below. For example, the thus controlled operation may comprise one or more of paging, monitoring load conditions or levels across multiple DUs under control of the CU, informing a communication control element or function in the radio access network, such as a base station or Node B, or deciding on suitability (such as e.g. need, appropriateness, expedience, or the like) of requesting a cell switch-on/off at the DU upon obtaining a cell switch-on/off request.

As mentioned above, the DU can provide a cell switch-on/off notification to the CU when/upon (autonomously/locally) triggering a cell switch-on/off (step 7). In this regard, the DU can notify energy state information and/or additional information, wherein the energy state information may include at least an energy state of at least one cell being subjected to cell switch-on/off triggered by the DU, and wherein the additional information may include e.g. one or more of an expected time of cell switch-on/off triggered by the DU, a current load condition or cell load level before cell switch-on/off triggered by the DU, an expected or estimated load condition or cell load level after cell switch-on/off triggered by the DU, an expected or estimated value of one or more KPIs, such as e.g. end-user throughput, cell throughput, packet latency, or the like, after cell switch-on/off triggered by the Du, or the like.

For example, the DU can provide the current energy saving state of at least the affected cell(s) (such as e.g. in service, switch-off going on for energy saving reason, cell deactivated for energy saving reason, etc.) upon every (triggered/initiated and/or effected/completed) change of a cell status. Along with the (triggered/initiated and/or effected/completed) cell status change, the DU can also provide additional information such as e.g. the expected time of cell switch-off, and/or the expected time of cell switch-on, and/or the current load level before switch-off, and/or the estimated cell load levels and/or KPIs, such as e.g. end-user throughput, cell throughput, packet latency, or the like, after the switch-off/-on.

As one example, the cell status information (e.g. the energy state information and/or the additional information) can be sent from the DU to the CU in advance. For example, a predicted cell energy (saving) state can be provided before enforcing the actual state change. In this regard, the predicted state change can be provided with a time tag (e.g. it can be (notified to be) applicable at a given time of the day and day of the week), for example.

As one example, the CU can store the cell status information (e.g. the energy state information and/or the additional information), and can take it into account for own procedures such as paging, for monitoring the load level across DUs or for informing neighbor gNBs via the Xn interface. Also, the CU can (be able to) request a cell switch-on/off if suitable or needed (e.g. after evaluation of traffic load in neighbor cells or upon reception of a corresponding message, such as XnAP CELL ACTIVATION REQUEST, from a neighbor NG-RAN node), and the request of cell switch-on/off sent from the CU to the DU can overwrite/overrule (or cancel) an autonomous/local cell switch-on/off decision at the DU.

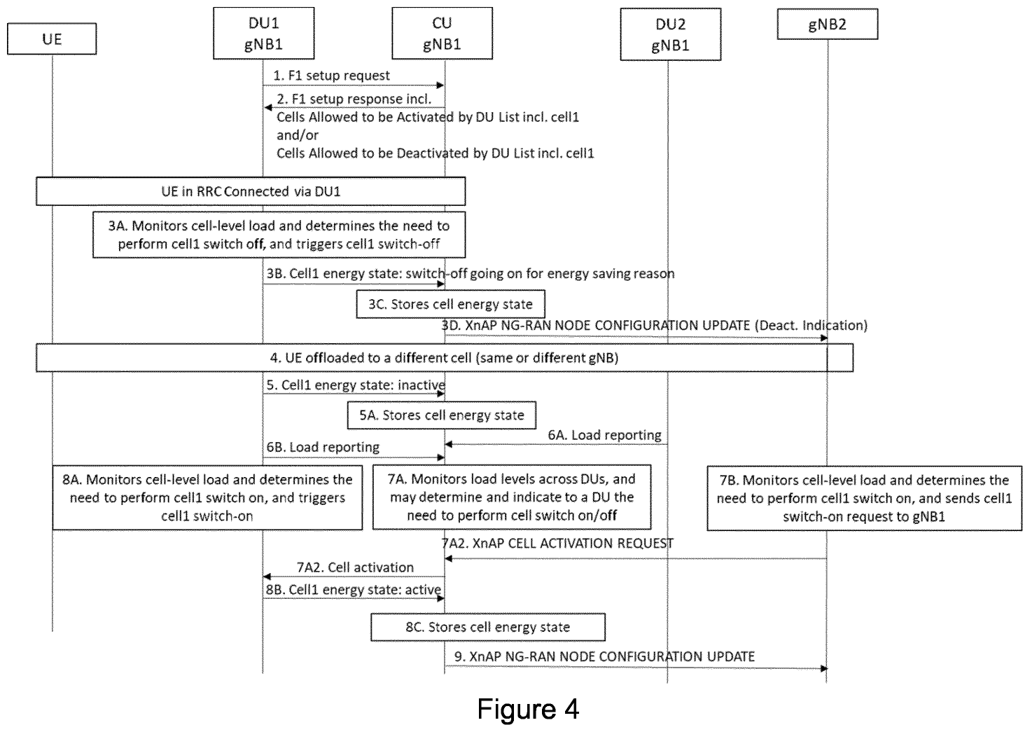

FIG. 4 shows a sequence diagram illustrating an example of a procedure according to at least one exemplifying embodiment. The procedure of FIG. 4 is mainly a procedure between a higher-layer entity, or an element, function or entity of similar/comparable functionality or operability, of/in a first gNB, which is denoted by CU-gNB1, and two lower-layer entities, or elements, functions or entities of similar/comparable functionality or operability, of/in the first gNB, which are denoted by DU1-gNB1 and DU2-gNB1, while involving a user equipment entity (camping in cell1) served by DU1-gNB1 and a second gNB as a neighbor to the first gNB, which is denoted by gNB2.

It is to be noted that the procedure of FIG. 4 exemplifies an example procedure in which certain aspects according to exemplifying embodiments are involved so as to facilitate the understanding of the applicability of such aspects. Accordingly, the procedure of FIG. 4 represents a non-limiting realization which is shown for illustration/explanation, without restricting the applicability of aspects according to exemplifying embodiments accordingly. In particular, it is not required that all of the thus illustrated phases/operations take place, and/or that messages, parameters, etc. as depicted are used.

As shown in FIG. 4, an interoperability is established between CU-gNB1 and DU1-gNB1 (steps 1 and 2). In this regard, CU-gNB1 provides a cell designation of targeted cells for (autonomous/local) switch-on/off by DU1-gNB1, which indicates cell 1 as a cell which is allowed to be subjected to for (autonomous/local) switch-on/off by DU1-gNB1 (step 2).

Assuming that UE is in RRC Connected mode via DU1-gNB1, DU1-gNB1 monitors the cell level load in/of cell 1, wherein it is assumed that DU1-gNB1 determines the suitability or need to switch off (i.e. deactivate) cell1 and, thus, triggers cell switch-off of/for cell 1 as cell 1 is included in the cell designation in terms of (autonomous/local) switch-off by DU1-gNB1 (step 3A). Upon triggering the cell1 switch-off, DU1-gNB1 notifies the energy state of cell1 to CU-gNB1, namely that, for cell1, switch-off is going on for energy saving reason (step 3B), which is stored by CU-gNB1 (step 3C). Based thereon, CU-gNB1 can provide a deactivation indication to gNB2 for informing its neighbor gNB about the cell1 switch-off (step 3D).

Then, DU1-gNB1 perform cell offloading of/for cell1 in order to realize the triggered cell1 switch-off (step 4). Upon completing the cell1 offloading and, thus, the cell1 switch-off, DU1-gNB1 notifies the energy state of cell1 to CU-gNB1, namely that cell1 is inactive (step 5), which is stored by CU-gNB1 (step 5A).

In the example procedure of FIG. 4, CU-gNB1 obtained load reporting (results) from its DUs, i.e. from DU1-gNB1 and DU2-gNB1 (steps 6A and 6B). Based thereon, CU-gNB1 monitors the load levels across its DUs (step 7A). Similar monitoring operations can also be performed by DU1-gNB1 and/or gNB2 (steps 8A and 7B). In the present example, it is assumed that gNB2 determines the suitability or need to switch on (i.e. re-/activate) cell1 and, thus, sends a corresponding switch-on request to CU-gNB1 as the CU of gNB1 controlling cell1 (step 7A2). Based on this request, CU-gNB1 requests cell activation of cell1 at/by DU1-gNB1 (step 7A2), as CU-gNB1 has stored and thus knows the cell status of cell1 as inactive. That is, CU-gNB1 controls its operation based on the stored energy state information of/for cell1.

Upon the cell activation request for cell1 from CU-gNB1, DU1-gNB1 performs re-/activation of cell1 (not shown), i.e. overwrites/overrules (or cancels) its preceding (autonomous/local) switch-off decision for cell1, and notifies CU-gNB1 accordingly. That is, DU1-gNB1 notifies CU-gNB1 that cell1 is active (step 8B), which is stored by CU-gNB1 (step 8C). Based thereon, CU-gNB1 can provide a re-/activation indication to gNB2 for informing its neighbor gNB about the cell1 switch-on (step 9).

As evident from the above, there are presented various methods, processes and procedures as well as related signaling capable of enhancing cell deactivation and re-/activation procedure in a CU-DU configuration/architecture. Thereby, (autonomous/local) cell deactivation and re-/activation decisions at DU level (rather than at CU level) are enabled, which e.g. allows faster decision-making and enforcement of/for the cell deactivation and re-/activation.

By virtue of exemplifying embodiments of the present disclosure, as evident from the above, there are provided measures/mechanisms for (enabling/realizing) efficient/favorable cell switch-on/off decisions in/for a radio access network of a mobile communication system. More specifically, measures/mechanisms for (enabling/realizing) enhanced cell on-/off-switching in/for a radio access network of a mobile communication system, which is applicable in a (distributed/disaggregated/split) configuration/architecture such as a CU-DU configuration/architecture, can be enabled/realized.

The above-described functionality as well as its related operations, procedures, methods and processes may be implemented by respective functional elements, entities, modules, units, processors, or the like, as described below. These functional elements, entities, modules, units, processors, or the like, i.e. the implementation of one or more exemplifying embodiments, may be realized in a cloud environment, by SDN, by NFV/NFVI, or the like.

While in the foregoing exemplifying embodiments of the present disclosure are described mainly with reference to operations, procedures, methods and processes, corresponding exemplifying embodiments of the present disclosure also cover respective apparatuses, entities, modules, units, network nodes and/or systems, including software and/or hardware thereof.

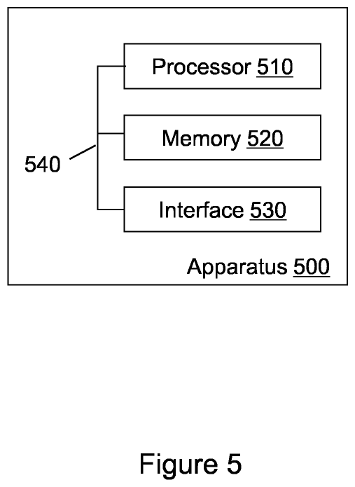

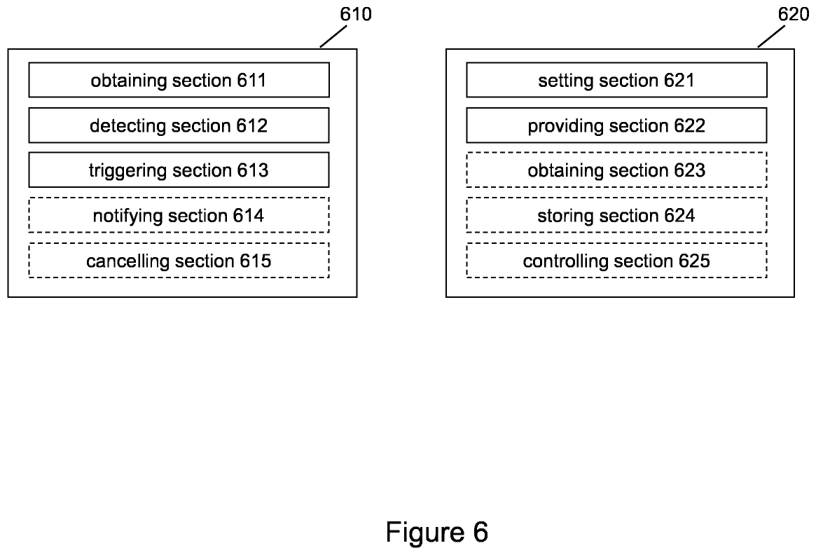

Respective exemplifying embodiments of the present invention are described below referring to FIGS. 5 and 6, while for the sake of brevity reference is made to the detailed description of respective corresponding configurations/setups, schemes, processes, sequences, methods as well as functionalities, principles and operations according to FIGS. 1 to 4.

In FIGS. 5 and 6, the blocks are basically configured to perform respective methods, procedures and/or functions as described above. The entirety of blocks are basically configured to perform the methods, procedures and/or functions as described above, respectively. With respect to FIGS. 5 and 6, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIGS. 5 and 6, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories or the like. Among others, one or more memories are provided for storing programs or program instructions for controlling or enabling the individual functional entities or any combination thereof to operate as described herein in relation to exemplifying embodiments.

FIG. 5 shows a schematic diagram illustrating an example of a structure of apparatuses according to at least one example embodiment. Herein, an apparatus can represent a physical entity or component, e.g. a structural device implementing a specific network element, entity or function or the functionality thereof as such, or a functional or logical entity or component. For example, the illustrated apparatus may be realized in or by a server or the like in a cloud environment, e.g. by a cloud-based implementation.

As indicated in FIG. 5, according to at least one example embodiment, an apparatus 500 may comprise or realize at least one processor 510 and at least one memory 520 (and possibly also at least one interface 530), which may be operationally connected or coupled, for example by a bus 540 or the like, respectively.

The processor 510 and/or the interface 530 of the apparatus 500 may also include a modem or the like to facilitate communication over a (hardwire or wireless) link, respectively. The interface 530 of the apparatus 500 may include a transmitter, receiver or transceiver connected or coupled to one or more antennas, antenna units, such as antenna arrays or communication facilities or means for (hardwire or wireless) communications with the linked, coupled or connected device(s), respectively. The interface 530 of the apparatus 500 is generally configured to communicate with at least one other apparatus, device, node or entity (in particular, the interface thereof).

The memory 520 of the apparatus 500 may represent a (non-transitory/tangible) storage medium (e.g. RAM, ROM, EPROM, EEPROM, etc.) and store respective software, programs, program products, macros or applets, etc. or parts of them, which may be assumed to comprise program instructions or computer program code that, when executed by the respective processor, enables the respective electronic device or apparatus to operate in accordance with example embodiments described herein. Further, the memory 520 of the apparatus 500 may (comprise a database to) store any data, information, or the like, which is used in the operation of the apparatus.

According to various example embodiments, respective apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the illustrated apparatus 500 can be used in practicing one or more of the example embodiments, as described herein.

When in the subsequent description it is stated that the processor (or some other means) is configured to perform some function, this is to be construed to be equivalent or corresponding to a description stating that a (i.e. at least one) processor or corresponding circuitry, potentially in cooperation with a computer program code stored in the memory of the respective apparatus or otherwise available (it should be appreciated that the memory may also be an external memory or provided/realized by a cloud service or the like), is configured to cause the apparatus to perform at least the thus mentioned function. It should be appreciated that herein processors, or more generally processing portions, should not be only considered to represent physical portions of one or more processors, but may also be considered as a logical division of the referred processing tasks performed by one or more processors.

According to at least one example embodiment, the illustrated apparatus 500 may represent or realize/embody a (part of a) lower-layer entity, or an element, function or entity of similar/comparable functionality or operability, in/for a radio access network of a mobile communication system, such as a communication and/or communication control unit like a Distributed Unit DU (of/in a gNB or 5G base station) in/for a 3GPP network or system. Hence, the apparatus 500 may be configured to perform a procedure and/or exhibit a functionality and/or implement a mechanism, as described (for a DU) in any one of FIGS. 1, 3 and 4.

Accordingly, the apparatus 500 may be caused or the apparatus 500 or its at least one processor 510 (possibly together with computer program code stored in its at least one memory 520) may be configured to obtain a cell designation, including an indication of one or more cells allowed to be switched on/off by the lower-layer entity among cells served by the lower-layer entity, from a higher-layer entity in the radio access network, to detect a cell switch-on/off condition for at least one cell based on at least a load condition of cells served by the lower-layer entity, and to trigger a cell switch-on/off of the at least one cell when the at least one cell is indicated in the cell designation.

According to at least one example embodiment, the illustrated apparatus 500 may represent or realize/embody a (part of a) a higher-layer entity, or an element, function or entity of similar/comparable functionality or operability, in/for a radio access network of a mobile communication system, such as a communication and/or communication control unit like a Central Unit CU (of/in a gNB or 5G base station) in/for a 3GPP network or system. Hence, the apparatus 500 may be configured to perform a procedure and/or exhibit a functionality and/or implement a mechanism, as described (for a CU) in any one of FIGS. 2, 3 and 4.

Accordingly, the apparatus 500 may be caused or the apparatus 500 or its at least one processor 510 (possibly together with computer program code stored in its at least one memory 520) may be configured to set among cells served by a lower-layer entity in the radio access network, one or more cells allowed to be switched on/off by the lower-layer entity, and to provide a cell designation, including an indication of the one or more cells allowed to be switched on/off by the lower-layer entity, to the lower-layer entity.

As mentioned above, an apparatus according to at least one example embodiment may be structured by comprising respective one or more units or means or circuitries for performing corresponding operations, procedures and/or functions. For example, such one or more units or means or circuitries may be implemented/realized on the basis of an apparatus structure, as illustrated in FIG. 5, e.g. by one or more processors 510, one or more memories 520, one or more interfaces 530, or any combination thereof.

FIG. 6 shows a schematic diagram illustrating an example of a structure of apparatuses according to at least one example embodiment.

As shown in FIG. 6, an apparatus 610 according to at least one example embodiment may represent or realize/embody a (part of a) lower-layer entity, or an element, function or entity of similar/comparable functionality or operability, in/for a radio access network of a mobile communication system, such as a communication and/or communication control unit like a Distributed Unit DU (of/in a gNB or 5G base station) in/for a 3GPP network or system. Hence, the apparatus 610 may be configured to perform a procedure and/or exhibit a functionality and/or implement a mechanism, as described (for a DU) in any one of FIGS. 1, 3 and 4.

Such apparatus 610 may comprise (at least) one or more unit/means/circuitry, denoted by service request obtaining section 611, which represent any implementation for (or configured to) obtaining (obtain) a cell designation, including an indication of one or more cells allowed to be switched on/off by the lower-layer entity among cells served by the lower-layer entity, from a higher-layer entity in the radio access network, one or more unit/means/circuitry, denoted by detecting section 612, which represent any implementation for (or configured to) detecting (detect) a cell switch-on/off condition for at least one cell based on at least a load condition of cells served by the lower-layer entity, and one or more unit/means/circuitry, denoted by triggering section 613, which represent any implementation for (or configured to) triggering (trigger) a cell switch-on/off of the at least one cell when the at least one cell is indicated in the cell designation.

Further, in the apparatus 610, the detecting section 612 may comprise one or more unit/means/circuitry which represent any implementation for (or configured to) monitoring (monitor), as the load condition, cell load levels of cells served by the lower-layer entity, and/or one or more unit/means/circuitry which represent any implementation for (or configured to) determining (determine) suitability of a cell switch-on/off based on at least the load condition, and selecting (select) the at least one cell for being switched on/off. Further, in the apparatus 610, the triggering section 613 may comprise one or more unit/means/circuitry which represent any implementation for (or configured to) initiating (initiate) cell offloading and cell deactivation or cell re-/activation. Further, in the apparatus 610, the obtaining section 611 may comprise one or more unit/means/circuitry which represent any implementation for (or configured to) receiving (receive) a message including the cell designation from the higher-layer entity, wherein the message can be or comprise a setup response message or a configuration update message or a configuration update acknowledgment message.

Further, such apparatus 610 may additionally/optionally further comprise one or more unit/means/circuitry, denoted by notifying section 614, which represent any implementation for (or configured to) notifying the higher-layer entity of the cell switch-on/off being triggered. If so, the notifying section 614 may comprise one or more unit/means/circuitry which represent any implementation for (or configured to) transmitting (transmit) a message including energy state information and/or additional information to the higher-layer entity, wherein the message can be or comprise a configuration update message or a configuration update acknowledgment message.

Further, such apparatus 610 may additionally/optionally further comprise one or more unit/means/circuitry, denoted by cancelling section 615, which represent any implementation for (or configured to) cancelling (cancel) the triggered cell switch-on/off when a requested cell switch-on/off differs from the triggered cell switch-on/off (according to a request for a cell switch-on/off from the higher-layer entity, which can be obtained by the obtaining section 611).

As shown in FIG. 6, an apparatus 620 according to at least one example embodiment may represent or realize/embody a (part of a) higher-layer entity, or an element, function or entity of similar/comparable functionality or operability, in/for a radio access network of a mobile communication system, such as a communication and/or communication control unit like a Central Unit CU (of/in a gNB or 5G base station) in/for a 3GPP network or system. Hence, the apparatus 620 may be configured to perform a procedure and/or exhibit a functionality and/or implement a mechanism, as described (for a CU) in any one of FIGS. 2, 3 and 4.

Such apparatus 620 may comprise (at least) one or more unit/means/circuitry, denoted by setting section 621, which represent any implementation for (or configured to) setting (set), among cells served by a lower-layer entity in the radio access network, one or more cells allowed to be switched on/off by the lower-layer entity, and one or more unit/means/circuitry, denoted by providing section 622, which represent any implementation for (or configured to) providing (provide) a cell designation, including an indication of the one or more cells allowed to be switched on/off by the lower-layer entity, to the lower-layer entity.

Further, in the apparatus 620, the providing section 622 may comprise one or more unit/means/circuitry which represent any implementation for (or configured to) transmitting (transmit) a message including the cell designation to the lower-layer entity, wherein the message can be or comprise a setup response message or a configuration update message or a configuration update acknowledgment message.

Further, such apparatus 620 may additionally/optionally further comprise one or more unit/means/circuitry, denoted by obtaining section 623, which represent any implementation for (or configured to) obtaining (obtain) a notification of a cell switch-on/off triggered by the lower-layer entity from the lower-layer entity. If so, the obtaining section 623 may comprise one or more unit/means/circuitry which represent any implementation for (or configured to) receiving a message including energy state information and/or additional information from the lower-layer entity, wherein the message can be or comprise a configuration update message or a configuration update acknowledgment message.

Further, such apparatus 620 may additionally/optionally further comprise one or more unit/means/circuitry, denoted by storing section 624, which represent any implementation for (or configured to) storing (store) the energy state information and/or the additional information, and one or more unit/means/circuitry, denoted by controlling section 625, which represent any implementation for (or configured to) controlling (control) an operation based on the stored information.

For further details regarding the operability/functionality of the apparatuses (or units/means thereof) according to exemplifying embodiments, reference is made to the above description in connection with any one of FIGS. 1 to 4, respectively.

According to exemplifying embodiments of the present disclosure, any one of the (at least one) processor, the (at least one) memory and the (at least one) interface, as well as any one of the illustrated units/means, may be implemented as individual modules, chips, chipsets, circuitries or the like, or one or more of them can be implemented as a common module, chip, chipset, circuitry or the like, respectively.

As used herein, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

According to exemplifying embodiments of the present disclosure, a system may comprise any conceivable combination of any depicted or described apparatuses and other network elements or functional entities, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, a basic system architecture of a (tele)communication network including a mobile communication system where some examples of exemplifying embodiments are applicable may include an architecture of one or more communication networks including wireless access network sub-/system(s) and possibly core network(s). Such an architecture may include one or more communication network control elements or functions, such as e.g. access network elements, radio access network elements, access service network gateways or base transceiver stations, like a base station, an access point, a NodeB (NB), an eNB or a gNB, a distributed or a centralized unit, which controls a respective coverage area or cell(s) and with which one or more communication stations such as communication elements or functions, like user devices or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. It should be appreciated that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of exemplifying embodiments may also be able to communicate with other networks, such as a public switched telephone network or the Internet, including the Internet-of-Things. The communication network may also be able to support the usage of cloud services for virtual network elements or functions thereof, wherein it is to be noted that the virtual network part of the (tele)communication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g. a cloud infrastructure.

Any method step is suitable to be implemented as software or by hardware without changing the idea of the present disclosure. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units/means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for (enabling/realizing) efficient/favorable cell switch-on/off decisions in/for a radio access network of a mobile communication system, which can be applicable in a (distributed/disaggregated/split) configuration/architecture such as a CU-DU configuration/architecture. Such measures exemplarily comprise that a lower-layer entity in/for a radio access network of a mobile communication system obtains a cell designation, including an indication of one or more cells allowed to be switched on/off by the lower-layer entity, from a higher-layer entity in the radio access network, detects a cell switch-on/off condition for at least one cell based on at least a load condition, and triggers a cell switch-on/off of the at least one cell when the at least one cell is indicated in the cell designation.

Even though the present disclosure is described above with reference to the examples according to the accompanying drawings, it is to be understood that the present disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

3GPP 3rd Generation Partnership Project
5G 5^{th} Generation
CU Central Unit
DU Distributed Unit
gNB gNodeB (5G/NR base station)
KPI Key Performance Indicator
NFV Network Functions Virtualisation
NFVI Network Functions Virtualisation Infrastructure
NG-RAN Next Generation Radio Access Network
NR New Radio
NR CGI New Radio Global Cell Identity
PCI Physical Cell Identity/Identifier
RRC Radio Resource Control
SSB Synchronization Signal Block
SDN Software-Defined Networking
UE User Equipment

1. A method of a lower-layer entity for a radio access network of a mobile communication system, comprising:
obtaining a cell designation, including an indication of one or more cells allowed to be switched on/off by the lower-layer entity among cells served by the lower-layer entity, from a higher-layer entity in the radio access network,
detecting a cell switch-on/off condition for at least one cell based on at least a load condition of cells served by the lower-layer entity, and
triggering a cell switch-on/off of the at least one cell, based on the detected cell switch-on/off condition for the at least one cell, when the at least one cell is indicated in the cell designation.

2-56. (canceled)

57. An apparatus of a lower-layer entity in a radio access network of a mobile communication system, comprising:
at least one processor; and
at least one memory storing instructions that, when executed by the at least one processor, cause the apparatus at least to perform:
obtaining a cell designation, including an indication of one or more cells allowed to be switched on/off by the lower-layer entity among cells served by the lower-layer entity, from a higher-layer entity in the radio access network
detecting a cell switch-on/off condition for at least one cell based on at least a load condition of cells served by the lower-layer entity, and
triggering a cell switch-on/off of the at least one cell, based on the detected cell switch-on/off condition for the at least one cell, when the at least one cell is indicated in the cell designation.

58. The apparatus according to claim 57, wherein the instructions, when executed by the at least one processor, cause the apparatus at least to perform:
monitoring, as the load condition, cell load levels of cells served by the lower-layer entity.

59. The apparatus according to claim 57, wherein the instructions, when executed by the at least one processor, cause the apparatus at least to perform:
determining suitability of a cell switch-on/off based on at least the load condition, and selecting the at least one cell for being switched on/off.

60. The apparatus according to claim 57, wherein
the cell designation includes an indication of one or more cells allowed to be switched off by the lower-layer entity,
a cell switch-off condition is detected for the at least one cell, and
a cell switch-off of the at least one cell is triggered when the at least one cell is indicated in the cell designation as a cell allowed to be switched off by the lower-layer entity.

61. The apparatus according to claim 60, wherein detecting the cell switch-off condition for the at least one cell comprises:
determining suitability of a cell switch-off when the load condition indicates decreasing, low or no load, and
selecting the at least one cell for being switched off based on cell-related information available at the lower-layer entity.

62. The apparatus according to claim 61, wherein the cell-related information comprises information on one or more of energy efficiency, energy consumption and energy saving gain or potential of cells served by the lower-layer entity.

63. The apparatus according to claim 61, or wherein the instructions, when executed by the at least one processor, cause the apparatus at least to perform:
initiating cell offloading and cell deactivation.

64. The apparatus according to claim 57, wherein
the cell designation includes an indication of one or more cells allowed to be switched on by the lower-layer entity,
a cell switch-on condition is detected for the at least one cell, and
a cell switch-on of the at least one cell is triggered when the at least one cell is indicated in the cell designation as a cell allowed to be switched on by the lower-layer entity.

65. The apparatus according to claim 64, wherein detecting the cell switch-on condition for the at least one cell comprises:
determining suitability of a cell switch-on when the load condition indicates increasing or high load or when the load condition indicates increasing or high load and one or more key performance indicators are decreasing, and
selecting the at least one cell for being switched on based on cell-related information available at the lower-layer entity.

66. The apparatus according to claim 65, wherein the cell-related information comprises information on one or more of energy efficiency, energy consumption and energy saving gain or potential of cells served by the lower-layer entity.

67. The apparatus according to claim 64, wherein the instructions, when executed by the at least one processor, cause the apparatus at least to perform:
initiating cell re-/activation.

68. The apparatus according to claim 57, wherein the instructions, when executed by the at least one processor, cause the apparatus at least to perform:
receiving a message including the cell designation from the higher-layer entity,
wherein the message is or comprises a setup response message or a configuration update message or a configuration update acknowledgment message.

69. The apparatus according to claim 57, wherein the instructions, when executed by the at least one processor, cause the apparatus at least to perform:
notifying the higher-layer entity of the cell switch-on/off being triggered.

70. The apparatus according to claim 69, wherein the cell switch-on/off is notified before and/or after the triggered cell switch-on/off is enforced.

71. The apparatus according to claim 69, wherein the instructions, when executed by the at least one processor, cause the apparatus at least to perform:
providing energy state information including at least an energy state of the at least one cell, and/or
providing additional information including one or more of an expected time of the cell switch-on/off, a current load condition or cell load level before the cell switch-on/off, an expected or estimated load condition or cell load level after the cell switch-on/off, and an expected or estimated value of one or more key performance indicators after the cell switch-on/off.

72. The apparatus according to claim 71, wherein the energy state comprises one of active, inactive, switch-off ongoing for energy saving reasons, and switched-off for energy saving reasons.

73. The apparatus according to claim 57, wherein the instructions, when executed by the at least one processor, cause the apparatus at least to perform:
transmitting a message including energy state information and/or additional information to the higher-layer entity,
wherein the message is or comprises a configuration update message or a configuration update acknowledgment message.

74. The apparatus according to claim 57, wherein the instructions, when executed by the at least one processor, cause the apparatus at least to perform:
obtaining a request for a cell switch-on/off from the higher-layer entity, and
cancelling the triggered cell switch-on/off when the requested cell switch-on/off differs from the triggered cell switch-on/off.

75. The apparatus according to claim 57, wherein
the lower-layer entity is or comprises a functional unit providing support for lower layers, such as Layer 1 and/or Layer 2, of a protocol stack for communication in the radio access network and/or the mobile communication system, and/or
the lower-layer entity is or comprises a distributed unit of a communication control element or function in the radio access network and, such as a base station or Node B, and/or
the higher-layer entity is or comprises a functional unit providing support for higher layers, such as Layer 3, of a protocol stack for communication in the radio access network and/or the mobile communication system, and/or
the higher-layer entity is or comprises a central unit of a communication control element or function in the radio access network and, such as a base station or Node B, and/or
the lower-layer entity and the higher-layer entity belong to a communication control element or function in the radio access network and, such as a base station or Node B, in distributed/split architecture.

76. An apparatus of a higher-layer entity for a radio access network of a mobile communication system, comprising:
at least one processor; and
at least one memory storing instructions that, when executed by the at least one processor, cause the apparatus at least to perform:
setting, among cells served by a lower-layer entity in the radio access network, one or more cells allowed to be switched on/off by the lower-layer entity, and
providing a cell designation, including an indication of the one or more cells allowed to be switched on/off by the lower-layer entity, to the lower-layer entity.

77-86. (canceled)
